(19) United States
(12) Patent Application Publication
(10) Pub. No.: US 2021/0132609 A1
(43) Pub. Date: May 6, 2021

(54) VARIABLE-HEIGHT PROXIMITY SENSORS ON AUTONOMOUS VEHICLES

(71) Applicant: Diversey, Inc., Fort Mill, SC (US)

(72) Inventors: Stephen D. Herr, Richmond, VA (US); Stephen J. Balas, Midlothian, VA (US); David M. Knuth, North Chesterfield, VA (US); Aurle Y. Gagne, Mechanicsville, VA (US); Philip Hennessy, Midlothian, VA (US); Samuel E. Elzarian, Richmond, VA (US); Kevin L. Thomas, Indian Trail, NC (US)

(21) Appl. No.: 16/491,772

(22) PCT Filed: Mar. 9, 2018
(86) PCT No.: PCT/US2018/021698

§ 371 Date: Sep. 6, 2019

Related U.S. Application Data
(60) Provisional application No. 62/469,579, filed on Mar. 10, 2017.

(51) Int. Cl. G05D 1/02

(52) U.S. Cl. CPC G05D 1/021; G05D 1/0231; G01S 13/931; G05D 1/0257; G05D 1/0255

(57) ABSTRACT

An autonomous vehicle is configured to move across a floor surface in an environment. The autonomous vehicle includes a proximity sensor that is positionable at different heights on the autonomous vehicle. A location of the autonomous vehicle within the environment is determined. A proximity sensor height is determined based on the location of the autonomous vehicle within the environment. The proximity sensor is positioned at a height on the autonomous vehicle based on the proximity sensor height. A signal is received from the proximity sensor where the signal is indicative of a distance to an object within the environment at the height of the proximity sensor on the autonomous vehicle. An operation of the autonomous vehicle can be controlled based on the signal indicative of the distance to the object.

### BACKGROUND

The present disclosure is in the technical field of autonomous vehicle sensors and navigation. More particularly, the present disclosure is directed to adapting proximity sensors to be useful in detecting objects around the autonomous vehicle for use in controlling operation of the autonomous vehicle.

Autonomous vehicles have the ability to minimize the human effort involved in performing everyday tasks. For example, autonomous vehicles may be used as cleaning devices to help maintain and clean surfaces, such as hardwood floors, carpets, and the like. While autonomous vehicles are useful, it can be challenging for autonomous vehicles to operate in a variety of different locations. This challenge is especially the case when an autonomous vehicle operates in an environment with a number of different types of objects and those types of objects are not always accurately detectable by the same arrangement of sensors located on the autonomous vehicle.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a method uses an autonomous vehicle that is configured to move across a floor surface in an environment. The autonomous vehicle includes a proximity sensor that is positionable at different heights on the autonomous vehicle. The method includes determining a location of the autonomous vehicle within the environment and determining a proximity sensor height based on the location of the autonomous vehicle within the environment. The method further includes positioning the proximity sensor at a height on the autonomous vehicle based on the proximity sensor height and receiving, from the proximity sensor, a signal indicative of a distance to an object within the environment at the height of the proximity sensor on the autonomous vehicle.

In one example, determining the location, determining the proximity sensor height, positioning the proximity sensor, and receiving the signal are performed by the autonomous vehicle. In another example, determining the location, determining the proximity sensor height, positioning the proximity sensor, and receiving the signal are performed by at least one of the autonomous vehicle and a remote computing device. In another example, each of the autonomous vehicle and the remote computing device performs at least one of determining the location, determining the proximity sensor height, positioning the proximity sensor, and receiving the signal. In another example, the autonomous vehicle is communicatively coupled to the remote computing device via a network. In another example, the method further includes controlling an operation of the autonomous vehicle based on the signal indicative of the distance to the object. In another example, the operation of the autonomous vehicle includes at least one of a position of the autonomous vehicle, an orientation of the autonomous vehicle, a speed of the autonomous vehicle, or an acceleration of the autonomous vehicle. In another example, the operation of the autonomous vehicle includes one or more of navigation relative to the object in the environment or object avoidance of the object in the environment.

In another example, the proximity sensor is positionable at a distinct number of different heights on the autonomous vehicle. In another example, the proximity sensor is positionable at any height within a range of heights on the autonomous vehicle. In another example, positioning the proximity sensor is performed while the autonomous vehicle is moving across the floor surface in the environment. In another example, determining the proximity sensor height based on the location of the autonomous vehicle within the environment includes determining that the location of the autonomous vehicle does not have a pre-associated proximity sensor height and determining the proximity sensor height using sensor readings from an on-board sensor. In another example, the proximity sensor is the on-board sensor and determining the proximity sensor height includes moving the proximity sensor to a number of the different heights and selecting one of the number of the different heights as the proximity sensor height based on readings of the proximity sensor at the number of the different heights. In another example, the location of the autonomous vehicle that does not have a preassociated proximity sensor height is an unknown location or an unmapped location.

In another embodiment a system includes an autonomous vehicle, a location element, a proximity sensor, and a movement mechanism. The autonomous vehicle is configured to move across a floor surface of an environment. The location element is configured to determine a location of the autonomous vehicle within the environment. The proximity sensor is coupled to the autonomous vehicle. The movement mechanism is configured to position the proximity sensor at different heights on the autonomous vehicle. The movement mechanism is configured to position the proximity sensor in response to receiving instructions based on a proximity sensor height, and the proximity sensor height is determined based on the location of the autonomous vehicle determined by the location element. The proximity sensor is configured to generate a signal indicative of a distance to an object within the environment at the height of the proximity sensor on the autonomous vehicle.

In one example, the autonomous vehicle further comprises at least one processing element and at least one memory having instructions stored therein, and the instructions, in response to execution by the at least one processing element, cause the autonomous vehicle to determine the proximity sensor height based on the location of the autonomous vehicle determined by the location element and instruct the movement mechanism to position the proximity sensor based on the proximity sensor height. In another example, the instructions, in response to execution by the at least one processing element, further cause the autonomous vehicle to control an operation of the autonomous vehicle based on the signal indicative of the distance to the object. In another example, the operation of the autonomous vehicle includes at least one of a position of the autonomous vehicle, an orientation of the autonomous vehicle a speed of the autonomous vehicle, or an acceleration of the autonomous vehicle. In another example, the operation of the autonomous vehicle includes one or more of navigation relative to the object in the environment or object avoidance of the object in the environment.

In another example, the system further includes a housing having at least one aperture and the proximity sensor is configured to direct a field through the at least one aperture toward the object in the environment. In another example, the at least one aperture includes a plurality of apertures, and wherein the movement mechanism is configured to selectively position the proximity sensor at one of the plurality of apertures. In another example, the at least one aperture includes an elongated aperture, and the movement mechanism is configured to selectively position the proximity sensor at any height between a lower end of the elongated aperture and an upper end of the elongated aperture. In another example, the system further includes a remote computing device communicatively coupled to the autonomous vehicle via a network and the remote computing device is configured to perform at least one of determining the location of the autonomous vehicle, determining the proximity sensor height based on the location of the autonomous vehicle, or instructing the movement mechanism to position the proximity sensor based on the proximity sensor height.

In another embodiment, a non-transitory computer-readable medium has instructions embodied thereon for using an autonomous vehicle. The autonomous vehicle is configured to move across a floor surface in an environment and the autonomous vehicle includes a proximity sensor that is positionable at different heights on the autonomous vehicle. The instructions, in response to execution by a processing element in the autonomous vehicle, cause the autonomous vehicle to determine a location of the autonomous vehicle within the environment, determine a proximity sensor height based on the location of the autonomous vehicle within the environment, position the proximity sensor at a height on the autonomous vehicle based on the proximity sensor height, and receive, from the proximity sensor, a signal indicative of a distance to an object within the environment at the height of the proximity sensor on the autonomous vehicle.

In one example, the instructions, in response to execution by the processing element in the autonomous vehicle, further cause the autonomous vehicle to control an operation of the autonomous vehicle based on the signal indicative of the distance to the object. In another example, the operation of the autonomous vehicle includes at least one of a position of the autonomous vehicle, an orientation of the autonomous vehicle, a speed of the autonomous vehicle, or an acceleration of the autonomous vehicle. In another example, the operation of the autonomous vehicle includes one or more of navigation relative to the object in the environment or object avoidance of the object in the environment. In another example, the proximity sensor is positionable at a distinct number of different heights on the autonomous vehicle. In another example, the proximity sensor is positionable at any height within a range of heights on the autonomous vehicle. In another example, the instructions to position the proximity sensor cause the proximity sensor to be positioned while the autonomous vehicle is moving across the floor surface in the environment.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIGS. 1A to 1D depict various instances of an embodiment of an environment in which an autonomous vehicle operates., in accordance with the embodiments disclosed herein;

FIGS. 2A to 2C depict examples of areas of an environment and views of the front of an autonomous vehicle as it is operating in the areas of the environment, in accordance with the embodiments disclosed herein;

FIGS. 3A to 3C depict examples of areas of an environment and views of the right side of an autonomous vehicle as it is operating in the areas of the environment, in accordance with the embodiments disclosed herein;

FIGS. 4A and 4B depict, respectively, right side and partial views of an embodiment of an autonomous vehicle that can detect objects in at a distinct number of different heights, in accordance with the embodiments disclosed herein;

FIGS. 5A and 5B depict, respectively, right side and partial views of another embodiment of an autonomous vehicle that can detect objects in at any number of different heights, in accordance with the embodiments disclosed herein;

FIG. 6A depicts an overhead view of a grocery store environment in which autonomous vehicles operate, in accordance with the embodiments disclosed herein;

FIGS. 6B to 6D depict, respectively, a rear view of each of three autonomous vehicles as they are operating in the grocery store environment depicted in FIG. 6A, in accordance with the embodiments disclosed herein;

FIGS. 7A and 7B depict, respectively, a block diagram of an autonomous vehicle and a block diagram of the autonomous vehicle and an associated system, in accordance with the embodiments disclosed herein;

FIG. 8 depicts an embodiment of a method for using a variable-height proximity sensor on an autonomous vehicle, in accordance with the embodiments disclosed herein;

FIG. 9 depicts an example embodiment of a system that may be used to implement some or all of the embodiments described herein; and

FIG. 10 depicts a block diagram of an embodiment of a computing device, in accordance with the embodiments described herein.

### DETAILED DESCRIPTION

The present disclosure describes embodiments of using a proximity sensor on an autonomous vehicle. In some embodiments, autonomous vehicles move across floor surfaces in environments. While moving across the floor surfaces of the environments, the autonomous vehicles may encounter a number of different objects. Some of the objects can be used for navigation relative to the object by controlling the movement of the autonomous vehicle based on sensor readings of distances to the objects. The detection of objects in an environment can be used for object avoidance so that the autonomous vehicle does not collide with the objects. However, such objects can be difficult to detect because of their differing shapes and sizes.

In some embodiments disclosed herein, an autonomous vehicle includes a proximity sensor that is positionable on the autonomous vehicle at different heights. A location of the autonomous vehicle within the environment is determined. A proximity sensor height is determined based on the location of the autonomous vehicle within the environment. The proximity sensor is positioned at a height on the autonomous vehicle based on the proximity sensor height. A signal is received from the proximity sensor where the signal is indicative of a distance to an object within the environment at the height of the proximity sensor on the autonomous vehicle. An operation of the autonomous vehicle can be controlled based on the signal indicative of the distance to the object.

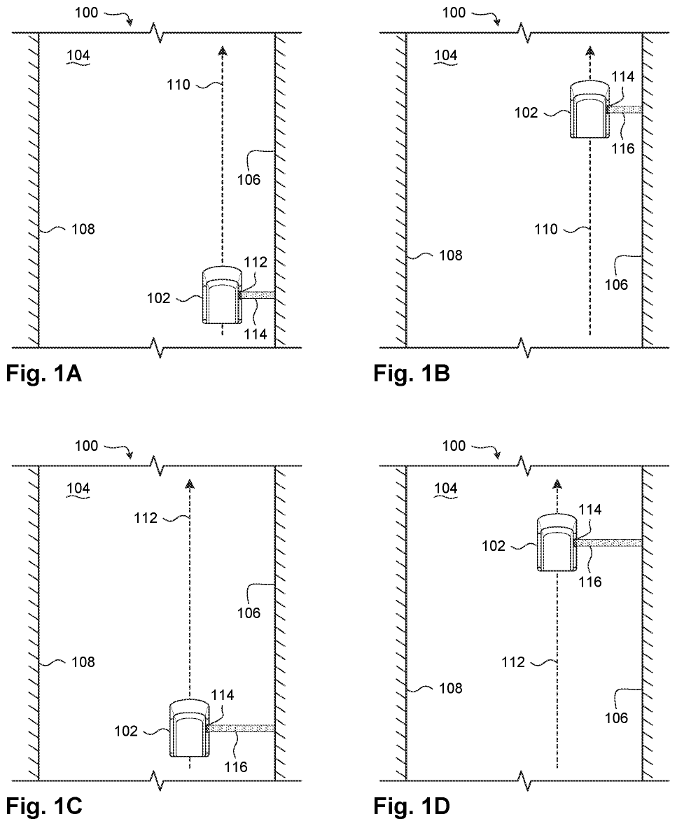

FIGS. 1A to 1D depict various instances of an embodiment of an environment 100 in which an autonomous vehicle 102 operates. As used herein, the term “autonomous vehicle” means a vehicle which is capable of controlling its operation (e.g., its movement and/or orientation) without user input. Autonomous vehicles may be capable of accepting user inputs to control their operation, but they are also capable of controlling their operation without user input. The environment 100 includes a floor surface 104 and the autonomous vehicle 102 is configured to move across the floor surface 104. In any of the embodiments disclosed herein, autonomous vehicles may be autonomous cleaning vehicles that are capable of performing a cleaning operation, such as vacuuming a floor surface, mopping a floor surface, polishing a floor surface, or otherwise cleaning the floor surface. The environment 100 also includes walls 106 and 108. The walls 106 and 108 may be boundaries of a corridor, a room, or any other feature of the environment.

The autonomous vehicle 102 may be capable of navigating through the environment 100 to follow particular routes. In the embodiment depicted in FIGS. 1A and 1B, the autonomous vehicle 102 follows a route 110 that is substantially parallel to the wall 106. In the embodiment depicted in FIGS. 1C and 1D, the autonomous vehicle 102 follows a route 112 that is substantially parallel to the wall 106. In one example, the route 110 and the route 112 may be subsequent passes of the autonomous vehicle 102 as the autonomous vehicle 102 cleans the floor surface 104 between the walls 106 and 108. While the walls 106 and 108 and the routes 110 and 112 are straight in the depicted embodiment, the walls 106 and 108 could be curved and the routes 110 and 112 could similarly be curved to maintain a particular offset between one or both of the walls 106 and 108 and the routes 110 and 112.

One difficulty with navigation of autonomous vehicles is the ability of the autonomous vehicle to maintain particular directions as they travel within an environment. One method of maintaining a particular direction with respect to walls is the use of a proximity sensor. In the embodiments depicted in FIGS. 1A to 1D, the autonomous vehicle 102 includes a proximity sensor 114 on the right side of the autonomous vehicle 102. The proximity sensor 114 emits a field 116 that extends from the proximity sensor 114 and impinges on an object in the environment 100. In the depicted embodiments, the field impinges on the wall 106. The proximity sensor 114 is configured to determine a distance from the proximity sensor 114 to the object that is impinged by the field 116. Some non-limiting examples of proximity sensors include: sonar sensors that emit a field of sound waves; single-point laser sensors that emit a field in the form of a fixed-direction beam of electromagnetic energy (e.g., ultraviolet, visible, or near infrared light); lidar sensors that emit a field of electromagnetic energy in multiple directions (e.g., multiple emitters arranged in different directions, a single emitter that changes directions, etc.); time of flight sensors that emit a field of objects (e.g., particles) or waves to determine a distance based on the time of travel of the object or wave; or any other sensors capable of detecting a distance to an object in an environment.

In the embodiments depicted in FIGS. 1A to 1D, the proximity sensor 114 is configured to emit the field 116 in a direction that is substantially perpendicular to the direction of travel of the autonomous vehicle 102. In some embodiments, the autonomous vehicle 102 is configured to control its operation based on a reading of distance by the proximity sensor 114. The autonomous vehicle 102 may be configured to attempt to maintain a particular offset between the autonomous vehicle 102 and the wall 106. For example, as the autonomous vehicle 102 moves from the instance depicted in FIG. 1A to the instance depicted in FIG. 1B, the autonomous vehicle 102 attempts to maintain a first offset of the autonomous vehicle 102 from the wall 106. In some embodiments, the autonomous vehicle 102 employs a feedback loop to control its operation to attempt to maintain the first offset. Similarly, as the autonomous vehicle 102 moves from the instance depicted in FIG. 1C to the instance depicted in FIG. 1D, the autonomous vehicle 102 attempts to maintain a second offset of the autonomous vehicle 102 from the wall 106. In some embodiments, the autonomous vehicle 102 employs a feedback loop to control its operation to attempt to maintain the second offset. The amount of the offset may be adjusted, such as when the offset is adjusted manually by a user, when an adjustment is sent wirelessly to the autonomous vehicle 102, when the autonomous vehicle 102 adjusts the offset (e.g., to perform a second cleaning pass through an area), and at other times.

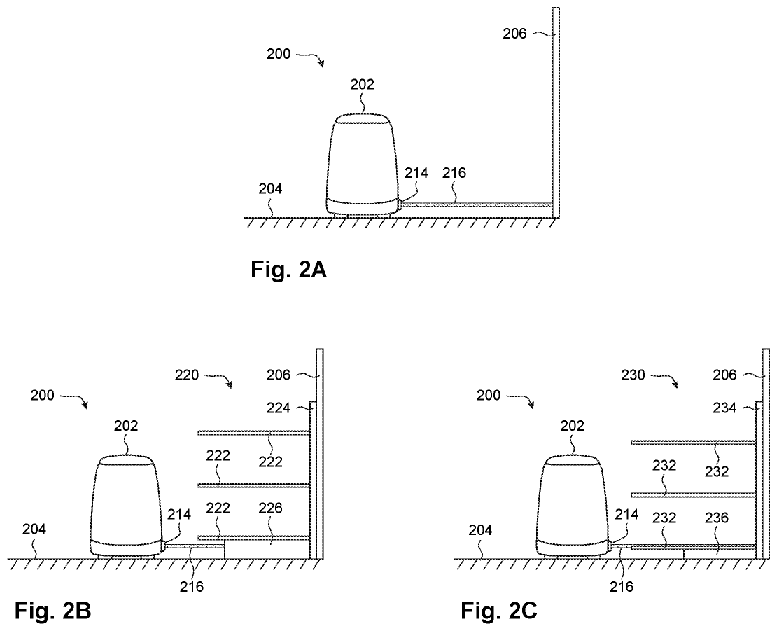

Depicted in FIGS. 2A to 2C are examples of areas of an environment 200 and views of the front of an autonomous vehicle 202 as it is operating in the areas of the environment 200. The environment 200 includes a floor surface 204 and the autonomous vehicle 202 is configured to move across the floor surface 204. The autonomous vehicle 202 includes a proximity sensor 214 on the left side of the autonomous vehicle 202. The proximity sensor 214 emits a field 216 that extends from the proximity sensor 214 and impinges on an object in the environment 200. The proximity sensor 214 is configured to determine a distance from the proximity sensor 214 to the object that is impinged by the field 216. In the embodiments depicted in FIGS. 2A to 2C, the proximity sensor 214 is configured to emit the field 216 in a direction that is substantially perpendicular to the direction of travel of the autonomous vehicle 202. The examples in FIGS. 2A to 2C also depict difficulties in using the proximity sensor 214.

In the area shown in FIG. 2A, the environment 200 includes a wall 206. The field 216 emitted by the proximity sensor 214 impinges on the wall 206. The proximity sensor 214 is capable of detecting the distance from the proximity sensor 214 to the wall 206. In some embodiments, the autonomous vehicle 202 is configured to control its operation based at least in part on the distance to the wall 206 detected by the proximity sensor 214. For example, the autonomous vehicle 202 may be configured to move parallel to the wall 206 at an offset distance from the wall 206 based on the distance detected by the proximity sensor 214.

In the area shown in FIG. 2B, the environment 200 includes the wall 206 and shelving 220 located against the wall 206. The shelving 220 includes shelves 222 that extend out from a back 224 and a kickplate 226 located under the lowermost of the shelves 222. The kickplate 226 supports the shelving 220 on the floor surface 204. The field 216 emitted by the proximity sensor 214 impinges on the kickplate 226. The proximity sensor 214 is capable of detecting the distance from the proximity sensor 214 to the kickplate 226. In some embodiments, the autonomous vehicle 202 is configured to control its operation based at least in part on the distance to the kickplate 226 detected by the proximity sensor 214. For example, the autonomous vehicle 202 may be configured to move parallel to the shelving 220 at an offset distance from the end of the shelves 222 based on the distance detected by the proximity sensor 214 to the kickplate 226. In one example, the distance from the kickplate 226 to the end of the shelves 222 is known to the autonomous vehicle 202 and the autonomous vehicle 202 takes that into account with the distance detected by the proximity sensor 214 to the kickplate 226.

In the area shown in FIG. 2C, the environment 200 includes the wall 206 and shelving 230 located against the wall 206. The shelving 230 includes shelves 232 that extend out from a back 234 and a kickplate 236 located under the lowermost of the shelves 232. The kickplate 236 supports the shelving 230 on the floor surface 204. The field 216 emitted by the proximity sensor 214 impinges partially on the lowermost of the shelves 232 and impinges partially on the back 234. In some cases, this partial impingement of the field 216 may not allow the proximity sensor 214 to arrive at any determination of distance. In other cases, this partial impingement of the field 216 may cause the proximity sensor 214 to arrive at a determination of distance that is unexpected (e.g., the proximity sensor may determine the distance to the back 234 when it is attempting to determine a distance to the end of the shelves 232. This problem may be further worsened if objects are placed on the lowermost of the shelves 232.

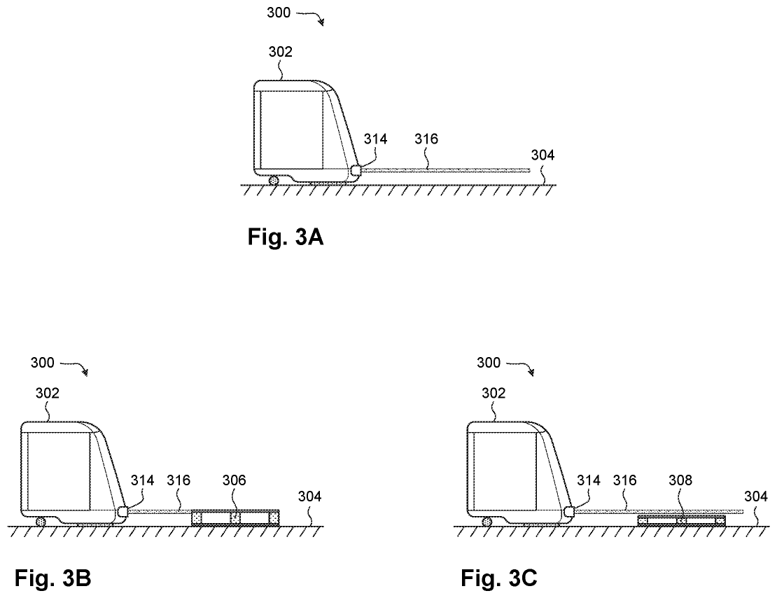

In the embodiments described above, the proximity sensors on the autonomous vehicles are positioned such that the fields emitted by the proximity sensors extend substantially perpendicular to the autonomous vehicles' direction of travel. This arrangement may permit the autonomous vehicles to use objects to the side of the autonomous vehicles as a guide for navigation. In other embodiments, proximity sensors on autonomous vehicles are positioned such that the fields are emitted by the proximity sensors in other directions and can be used for other purposes. Depicted in FIGS. 3A to 3C are embodiments of autonomous vehicles with proximity sensors arranged to emit fields in directions other than directions substantially perpendicular to the autonomous vehicles' direction of travel.

Depicted in FIGS. 3A to 3C are examples of areas of an environment 300 and views of the right side of an autonomous vehicle 302 as it is operating in the areas of the environment 300. The environment 300 includes a floor surface 304 and the autonomous vehicle 302 is configured to move across the floor surface 304. The autonomous vehicle 302 includes a proximity sensor 314 on the front side of the autonomous vehicle 302. The proximity sensor 314 emits a field 316 that extends from the proximity sensor 314. The proximity sensor 314 is configured to determine a distance from the proximity sensor 314 to an object that is impinged by the field 316. In the embodiments depicted in FIGS. 3A to 3C, the proximity sensor 314 is configured to emit the field 316 in a direction that is substantially parallel to the direction of travel of the autonomous vehicle 302. In some cases, the distances determined by the proximity sensor 314 may be used for object avoidance as the autonomous vehicle navigates the environment 300. The examples in FIGS. 3A to 3C also depict difficulties in using the proximity sensor 314 for object avoidance.

In the area shown in FIG. 3A, the environment 300 there is no object in front of the autonomous vehicle 302 that are impinged by the field 316. In response to determining that the field 316 does not impinge on any object, the proximity sensor 314 may generate a signal indicative that no object is detected in front of the proximity sensor 314. In some embodiments, the autonomous vehicle 302 is configured to continue moving in the same path in response to receiving the signal indicative that no object is detected in front of the proximity sensor 314.

In the area shown in FIG. 3B, the environment 300 includes a pallet 306 located on the floor surface 304. In this example, the environment 300 may be a portion of a warehouse, shipping dock, or other location where pallets are used. As shown in FIG. 3B, the field 316 impinges on the pallet 306. The proximity sensor 314 is capable of detecting the distance from the proximity sensor 314 to the pallet 306. In some embodiments, the autonomous vehicle 302 is configured to control its operation based at least in part on the distance to the pallet 306 detected by the proximity sensor 314. For example, the autonomous vehicle 302 may alter its orientation of travel in order to avoid running into the pallet 306.

In the area shown in FIG. 3C, the environment 300 includes a pallet 308 located on the floor surface 304. In this example, the environment 300 may be a portion of a warehouse, shipping dock, or other location where pallets are used. The area of the environment 300 shown in FIG. 3C may be a different area than the area shown in FIG. 3B. In this particular example, the height of the pallets used in the area shown in FIG. 3C are shorter than the pallets used in the area shown in FIG. 3B. As shown in FIG. 3C, the field 316 does not impinge on the pallet 308. Because field 316 does not impinge on the pallet 308, the proximity sensor 314 is not capable of detecting the distance from the proximity sensor 314 to the pallet 308. Unless the autonomous vehicle 302 has another sensor for detecting the pallet 308, the autonomous vehicle 302 may navigate directly into the pallet 308.

As shown above, a proximity sensor mounted to a side of an autonomous vehicle may be useful for navigating, including following an offset from a fixed object and avoidance of movable objects. However, these solutions have drawbacks in that proximity sensors fixedly mounted to autonomous vehicles do not provide accurate readings in all environments. It would be advantageous to have a way to accommodate for objects at a variety of different heights with respect to floor surfaces.

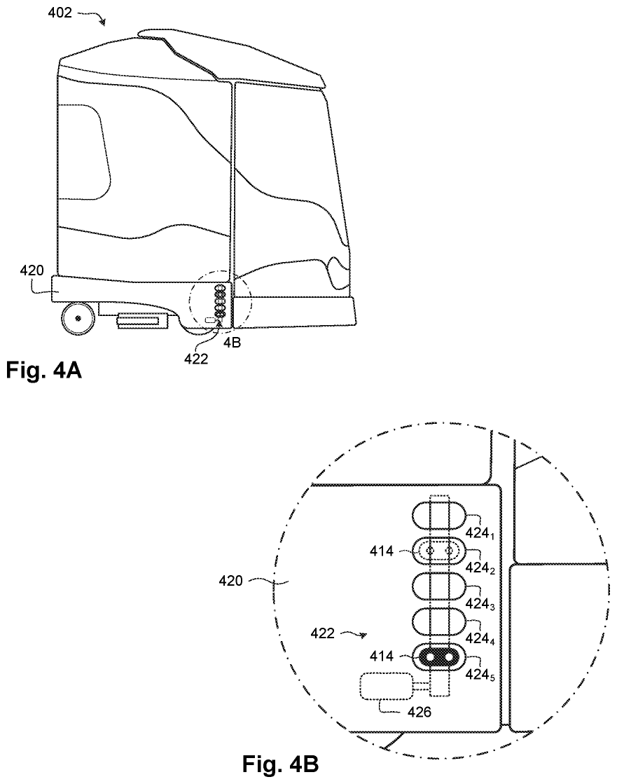

FIGS. 4A and 4B depict, respectively, right side and partial views of an embodiment of an autonomous vehicle 402 that can detect objects at a distinct number of different heights. The autonomous vehicle 402 includes a housing 420 that covers particular components of the autonomous vehicle 402, such as motors, batteries, central processing units, cleaning implements, and the like. In the depicted embodiment, the autonomous vehicle 402 has a variable-height proximity sensor system 422. The variable-height proximity sensor system 422 includes a proximity sensor 414, apertures 424₁, 424₂, 424₃, 424₄, and 424₅ (collectively, apertures 424) in the housing 420, and a movement mechanism 426 configured to move the proximity sensor 414. In some embodiments, the movement mechanism 426 includes one or more of a solenoid, an electric motor, a mechanical actuator, a solenoid, a hydraulic actuator, an electromechanical actuator, or any other mechanism capable of moving the proximity sensor 414. In some embodiments, the movement mechanism 426 is coupled to the proximity sensor 414 via one or more movement translation mechanisms, such as a rotational-to-linear translation system (e.g., a rack and pinion system, a screw jack, etc.), gears, belts, cam actuators, any other movement translation mechanism, or any combination thereof.

In the depicted embodiment, the apertures 424 include five distinct apertures. The proximity sensor 414 is capable of being positioned to emit a field through any one of the apertures 424. In the embodiment shown in FIG. 4B, the proximity sensor 414 is positioned at and configured to emit a field through aperture 424₅. This allows the proximity sensor 414 to detect a distance to an object in the environment outside the autonomous vehicle 402 at the height of the aperture 424₅. The proximity sensor 414 can be positioned by the movement mechanism 426 by moving the proximity sensor 414 to a different one of the apertures 424. In the depicted embodiment, a different position of the proximity sensor 414 is depicted using dashed lines at the aperture 424₂. If the proximity sensor 414 is moved to the aperture 424₂, the proximity sensor 414 would then be able to detect a distance to an object in the environment outside the autonomous vehicle 402 at the height of the aperture 424₂. This allows the proximity sensor 414 to be moved to different heights with respect to the floor surface on which the autonomous vehicle 402 moves in order to properly detect objects within the environment.

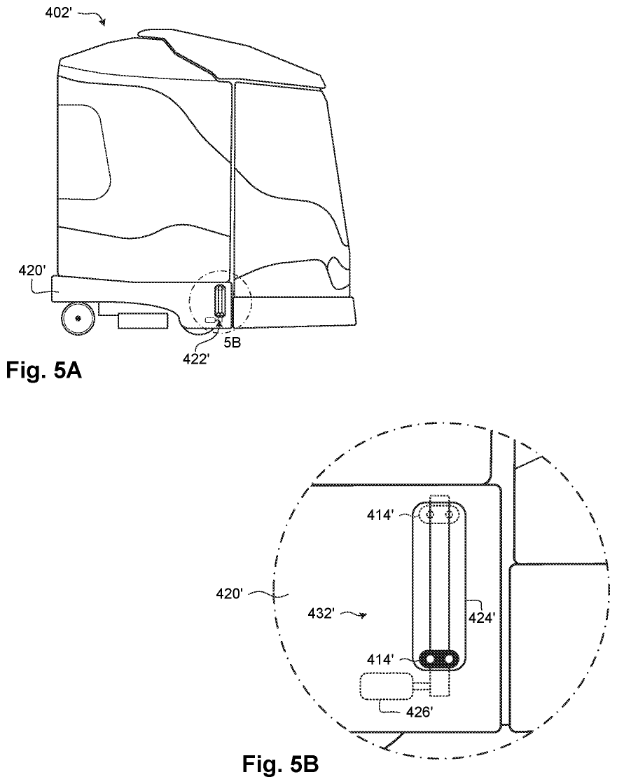

FIGS. 5A and 5B depict, respectively, right side and partial views of another embodiment of an autonomous vehicle 402′ that can detect objects in any number of different heights. The autonomous vehicle 402′ includes a housing 420′ that covers particular components of the autonomous vehicle 402′, such as motors, batteries, central processing units, cleaning implements, and the like. In the depicted embodiment, the autonomous vehicle 402′ has a variable-height proximity sensor system 422′. The variable-height proximity sensor system 422′ includes a proximity sensor 414′, an aperture 424′ in the housing 420′, and a movement mechanism 426′ configured to move the proximity sensor 414′. In some embodiments, the movement mechanism 426′ includes one or more of a solenoid, an electric motor, a mechanical actuator, a hydraulic actuator, an electromechanical actuator, or any other mechanism capable of moving the proximity sensor 414′. In some embodiments, the movement mechanism 426′ is coupled to the proximity sensor 414′ via one or more movement translation mechanisms, such as a rotational-to-linear translation system (e.g., a rack and pinion system, a screw jack, etc.), gears, belts, cam actuators, any other movement translation mechanism, or any combination thereof.

In the depicted embodiment, the aperture 424′ is an elongated aperture. The proximity sensor 414′ is capable of being positioned at any number of positions within the aperture 424′ to emit a field through the aperture 424′. In the embodiment shown in FIG. 5B, the proximity sensor 414′ is positioned at the lower end of the aperture 424′ and configured to emit a field through aperture 424′. This allows the proximity sensor 414′ to detect a distance to an object in the environment outside the autonomous vehicle 402′ at the height of the lower end of the aperture 424′. The proximity sensor 414′ can be positioned by the movement mechanism 426′ by moving the proximity sensor 414′ to a different location within the aperture 424′. In the depicted embodiment, a different position of the proximity sensor 414′ at the upper end of the aperture 424′ is depicted using dashed lines. If the proximity sensor 414′ is moved to the upper end of the aperture 424′, the proximity sensor 414′ would then be able to detect a distance to an object in the environment outside the autonomous vehicle 402′ at the height of the upper end of the aperture 424′. Because the aperture 424′ is an elongated aperture, the proximity sensor 414′ may be positioned at any position between the lower end of the aperture 424′ and the upper end of the aperture 424′. This allows the proximity sensor 414′ to be moved, within the range of the aperture 424′, to any height with respect to the floor surface on which the autonomous vehicle 402′ moves in order to properly detect objects within the environment.

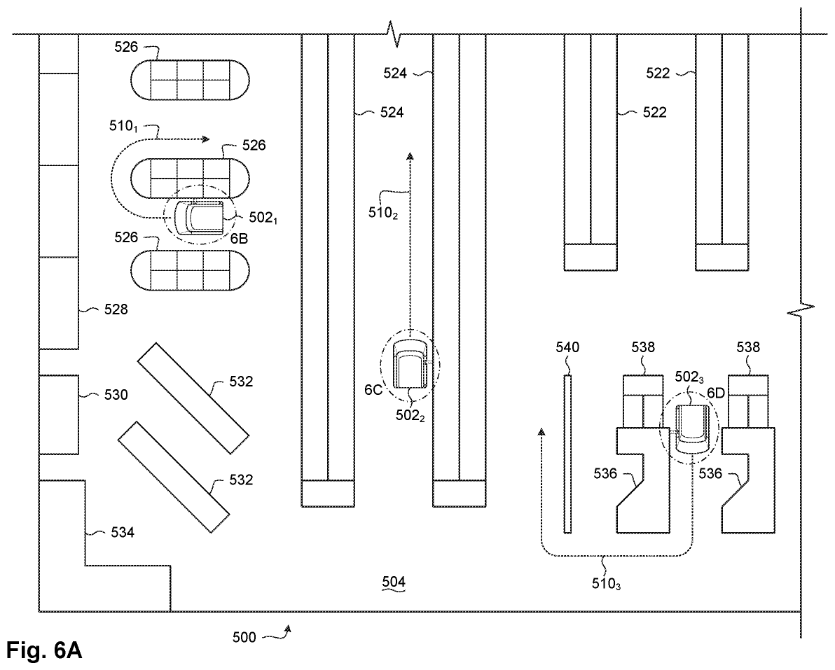

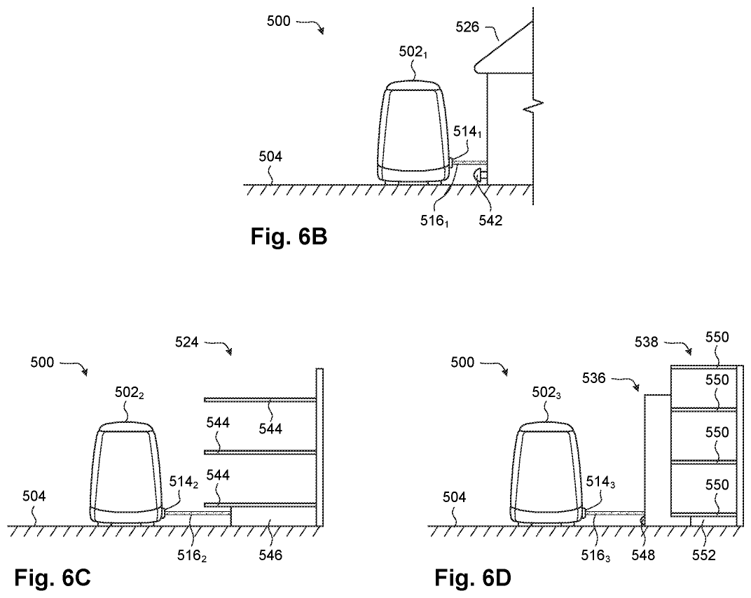

The ability to move a proximity sensor on an autonomous vehicle to different heights can be particularly useful if controlled based on the location of the autonomous vehicle within an environment. This benefit can be obtained regardless of whether the proximity sensor is positionable at a distinct number of heights (e.g., the variable-height proximity sensor system 422 on autonomous vehicle 402) or at any number of different heights (e.g., the variable-height proximity sensor system 422′ on autonomous vehicle 402′). Examples of the benefits of this ability are depicted in FIGS. 6A to 6D.

Depicted in FIG. 6A is an overhead view of a grocery store environment 500 in which autonomous vehicles 502₁, 502₂, and 502₃ (collectively autonomous vehicles 502) operate. The autonomous vehicles 502 are configured to move across a floor surface 504 in the grocery store environment 500. The floor surface 504 may be a single type of flooring substrate or any combination of flooring substrate. Non-limiting examples of types of flooring substrate include ceramic tile, vinyl, vinyl composition, vinyl asbestos, sheet vinyl, linoleum, concrete, wood, terrazzo, marble, slate, ceramic tile, brick, and granite. The flooring surface 504 may also include a coating or any combination of coatings over the flooring substrate.

The grocery store environment 500 includes a number of fixtures placed on the floor surface 504. The grocery store environment 500 includes shelves 522 and shelves 524. The shelves 522 and 524 are spaced apart to form aisles between neighboring ones of the shelves 522 and 524. The grocery store environment 500 also includes produce islands 526 and produce display shelves 528 that are located to the left of the shelves 524. The grocery store environment 500 also includes bakery display case 530, bakery display tables 532, and bakery corner display 534. The grocery store environment 500 also includes checkout stands 536. Checkout endcap shelves 538 are located next to the checkout stands 536 and a railing 540 provides a barrier between the checkout stands 536 and the shelves 524.

In the depicted embodiment, the autonomous vehicles 502 are moving across the floor surface 504 in the grocery store environment 500. The autonomous vehicle 502₁ is moving along a route 510₁ that is at an offset from one of the produce islands 526. The autonomous vehicle 502₂ is moving along a route 510₂ that is at an offset from one of the shelves 524. The autonomous vehicle 502₃ is moving along a route 510₃ that passes between the checkout stands 536 at an offset from one of the checkout stands 536, turns along an end of and at an offset from one of the checkout stands 536, and then turns along the railing 540 at an offset from the railing 540. A rear view of each of the autonomous vehicle 502₁, autonomous vehicle 502₂, and autonomous vehicle 502₃ is depicted, respectively, in FIGS. 6B to 6D.

In FIG. 6B, the rear of the autonomous vehicle 502₁ is depicted. The autonomous vehicle 502₁ has a variable-height proximity sensor 514₁. The proximity sensor 514₁ emits a field 516₁ to the right side of the autonomous vehicle 502₁ such that the variable-height proximity sensor 514₁ is capable of detecting a distance to an object to the right of the autonomous vehicle 502₁ in the grocery store environment 500. To the right of the autonomous vehicle 502₁ is one of the produce islands 526 that has a bumper 542. The shape of the bumper 542 may not permit the variable-height proximity sensor 514₁ to get an accurate reading of the location of the bumper 542 and the bumper 542 may not extend continuously around the produce island 526. The variable-height proximity sensor 514₁ has been positioned at a height with respect to the floor surface 504 so that the field 516₁ is above the bumper 542 and impinges on the produce island 526. This allows the variable-height proximity sensor 514₁ to get a reliable reading of the distance to the produce island 526 and the autonomous vehicle 502₁ to control its operation based on a signal from the variable-height proximity sensor 514₁ in order to follow the route 510₁.

In FIG. 6C, the rear of the autonomous vehicle 502₂ is depicted. The autonomous vehicle 502₂ has a variable-height proximity sensor 514₂. The variable-height proximity sensor 514₂ emits a field 516₂ to the right side of the autonomous vehicle 502₂ such that the variable-height proximity sensor 514₂ is capable of detecting a distance to an object to the right of the autonomous vehicle 502₂ in the grocery store environment 500. To the right of the autonomous vehicle 502₂ is one of the shelves 524 that has individual shelves 544 and a kickplate 546. The shape of the individual shelves 544 and/or items placed on the individual shelves 544 may not permit the variable-height proximity sensor 514₂ to get an accurate reading of the location of the ends of the individual shelves 544. However, the kickplate 546 may provide a reliable surface for the variable-height proximity sensor 514₂ to get an accurate reading of the location of the kickplate 546. The variable-height proximity sensor 514₂ has been positioned at a height with respect to the floor surface 504 so that the field 516₂ is below the individual shelves 544 and impinges on the kickplate 546. This allows the variable-height proximity sensor 514₂ to get a reliable reading of the distance to the kickplate 546 and the autonomous vehicle 502₂ to control its operation based on a signal from the variable-height proximity sensor 514₂ in order to follow the route 510₂.

In FIG. 6D, the rear of the autonomous vehicle 502₃ is depicted. The autonomous vehicle 502₃ has a variable-height proximity sensor 514₃. The variable-height proximity sensor 514₃ emits a field 516₃ to the right side of the autonomous vehicle 502₃ such that the variable-height proximity sensor 514₃ is capable of detecting a distance to an object to the right of the autonomous vehicle 502₃ in the grocery store environment 500. To the right of the autonomous vehicle 502₃ is one of the checkout stands 536 and one of the checkout endcap shelves 538. As can be seen in FIG. 6A, the field 516₃ of the autonomous vehicle 502₃ is aligned with the checkout stand 536 after having moved beyond the point at which the field 516₃ was aligned with the checkout endcap shelf 538. The checkout stand 536 includes a bumper 548 near the floor surface 504. The checkout endcap shelf 538 has individual shelves 550 and a kickplate 552 near the floor surface 504.

The shape of the bumper 548 may not permit the variable-height proximity sensor 514₃ to get an accurate reading of the location of the bumper 548 and the bumper 548 may not extend continuously around the checkout stand 536. The variable-height proximity sensor 514₃ has been positioned at a height with respect to the floor surface 504 so that the field 516₃ is above the bumper 548 and impinges on the checkout stand 536. This allows the variable-height proximity sensor 514₃ to get a reliable reading of the distance to the checkout stand 536 and the autonomous vehicle 502₃ to control its operation based on a signal from the variable-height proximity sensor 514₃ in order to follow the route 510₃.

As can be seen in FIG. 6D, the height of the variable-height proximity sensor 514₃ used to detect the distance to the checkout stand 536 may not be the best height to detect the distance to the checkout endcap shelf 538. More specifically, if the field 516₃ was aligned with the checkout endcap shelf 538 at the height of the variable-height proximity sensor 514₃ shown in FIG. 6D, the field 516₃ would impinge on the end of one of the individual shelves 550 when a more reliable reading would be obtained by the variable-height proximity sensor 514₃ with the field 516₃ impinging on the kickplate 552. However, the level of the kickplate 552 is approximately the same level of the bumper 548. Thus, as the autonomous vehicle 502₃ moves in the grocery store environment 500, the variable-height proximity sensor 514₃ can be located at a height so that the field 516₃ impinges on the kickplate 552 below the individual shelves 550 as the field 516₃ is aligned with the checkout endcap shelf 538, and then the variable-height proximity sensor 514₃ can be raised to a height so that the field 516₃ impinges on the checkout stand 536 above the bumper 548 as the field 516₃ is aligned with the checkout stand 536.

While the grocery store environment 500 has been depicted in FIGS. 6A to 6D and used as an example in the associate descriptions herein, variable-height proximity sensors on autonomous vehicles can be similarly useful in a number of other environments. In one embodiment, an autonomous vehicle with a variable-height proximity sensor can be used in an airport environment with the variable-height proximity sensor being moved to be able to detect a distance to check-in counters, baggage claim carousels, security checkpoint apparatuses, and the like. In another embodiment, an autonomous vehicle with a variable-height proximity sensor can be used in a hospital environment with the variable-height proximity sensor being moved to be able to detect a distance to hospital beds, nursing station desks, large medical equipment, and the like. In another embodiment, an autonomous vehicle with a variable-height proximity sensor can be used in a warehouse environment with the variable-height proximity sensor being moved to be able to detect a distance to pallets of differing heights (e.g., the pallets 306 and 308), warehouse shelving, packaging stations, and the like.

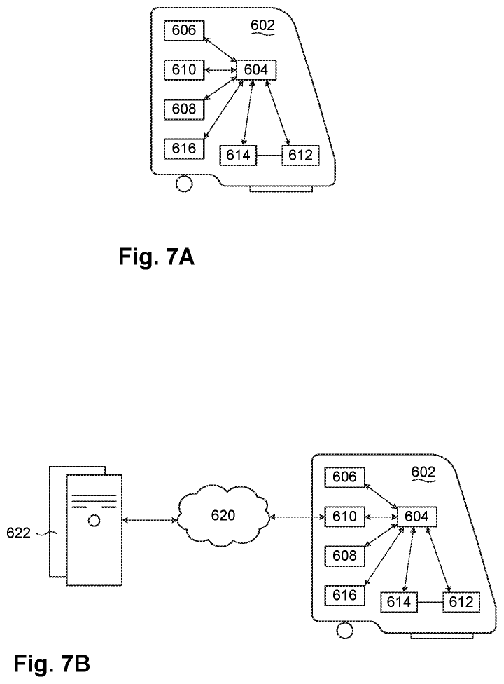

Depicted in FIGS. 7A and 7B are, respectively, a block diagram of an autonomous vehicle 602 and a block diagram of the autonomous vehicle 602 and an associated system. In the embodiment shown in FIG. 7A, the autonomous vehicle 602 includes a processing element 604, such as a central processing unit. The processing element 604 is communicatively coupled to a location element 606 that is configured to determine a location of the autonomous vehicle 602. In some embodiments, the location element 606 is configured to determine the location of the autonomous vehicle 602 based on one or more of signals received from the global positioning satellite (GPS) system, signals received from wireless communication network ports (e.g., WiFi hotspots, Bluetooth location beacons, etc.), comparisons of readings from on-board sensors to known features in the environment, and the like.

The autonomous vehicle 602 also includes memory 608 configured to store information. The memory 608 is communicatively coupled to the processing element 604. In some embodiments, the memory 608 includes information about proximity sensor heights based on areas within an environment. For example, using the embodiment of the grocery store environment 500 show in FIG. 6A as an example, the memory 608 may include proximity sensor heights for areas near each of the shelves 522 and 524, the produce islands 526, the produce display shelves 528, the bakery display case 530, the bakery display tables 532, the bakery corner display 534, the checkout stands 536, the checkout endcap shelves 538, and the railing 540. In some embodiments, the location can include a position and/or an orientation of the autonomous vehicle 602 within an environment. In one embodiment, the processing element 604 receives an indication of the location of the autonomous vehicle 602 from the location element 606 and, in response to receiving the indication of the location, the processing element 604 identifies a proximity sensor height for the location of the autonomous vehicle 602 from the memory 608. In some embodiments, the memory 608 contains instructions that, upon execution by the processing element 604, cause the processing element 604 to perform any or all of the functions described herein.

The autonomous vehicle 602 also includes a movement mechanism 612 and a proximity sensor 614. Each of the movement mechanism 612 and the proximity sensor 614 is communicatively coupled to the processing element 604. The movement mechanism 612 is coupled to the proximity sensor 614 such that the movement mechanism 612 is configured to move the proximity sensor 614 to change its height with respect to a floor surface upon which the autonomous vehicle 602 moves. The processing element 604 is capable of instructing the movement mechanism 612 to change the height of the proximity sensor 614. The proximity sensor 614 is configured to send signals to the processing element 604 indicative of distances from the proximity sensor 614 to objects in an environment. In one embodiment, after the processing element 604 identifies a proximity sensor height for the location of the autonomous vehicle 602, the processing element 604 controls the height of the proximity sensor 614 by instructing the movement mechanism 612 to change the height of the proximity sensor 614 based on the proximity sensor height.

The autonomous vehicle 602 also includes operation elements 616. The operation elements 616 are configured to control operation of the autonomous vehicle 602 within the environment. Examples of operation of the autonomous vehicle 602 include a position of the autonomous vehicle 602, an orientation of the autonomous vehicle 602, a speed of the autonomous vehicle 602, an acceleration of the autonomous vehicle 602, a floor cleaning by the autonomous vehicle 602, and the like. The operation elements 616 are communicatively coupled to the processing element 604. In one embodiment, after the processing element 604 receives a signal indicative of a distance from the proximity sensor 614 to objects in an environment, the processing element 604 controls one or more of the operation elements 616 based on the signal indicative of the distance from the proximity sensor 614 to objects in the environment. For example, the processing element 604 may control the operation elements 616 to affect the direction and/or the speed of the autonomous vehicle 602 in the environment.

In the embodiment depicted in FIG. 7B, the autonomous vehicle 602 includes the processing element 604, the location element 606, the memory 608, the movement mechanism 612, the proximity sensor 614, and the operation elements 616. The autonomous vehicle 602 also includes a communication interface 610. In one example, the communication interfaces 610 includes a transceiver configured to send and receive information via a wireless communication protocol, such as WiFi, Bluetooth, near field communication (NFC), cellular Long Term Evolution (LTE), and the like. The communication interface 610 is communicatively coupled to the processing element 604. The communication interface 610 is also communicatively coupled to a network 620, such as a WiFi network, a cellular network, and the like. The network 620 may be a wireless network, a wired network, or any combination thereof. The communications interface 610 is configured to send data across and receive data from the network 620.

As depicted in FIG. 7B, the network 620 is communicatively coupled to a remote computing device 622. The remote computing device 622 may be a server, a desktop computing device, a laptop computing device, a table computing device, a cellular telephone, or any other form of computing device. The remote computing device 622 is configured to receive information from and send information across the network 620. More specifically, the autonomous vehicle 602 and the remote computing device 622 are configured to send information to and receive information from each other via the network 620. In some embodiments, the network 620 is a private network, such as a local area network (LAN). In one example, the remote computing device 622 is a desktop computer operating in the same facility as the autonomous vehicle 602 and the network 620 is a private network within that facility. In some embodiments, the network 620 is a public network, such as a cellular network or the internet. In one example, the remote computing device 622 is a server located in a data center that is remote from the facility in which the autonomous vehicle 602 operates. In the case of public networks, the information sent over the network 620 may be encrypted prior to transmission and decrypted after reception. In some embodiments, the network 620 is a combination of public and private networks.

In the system depicted in FIG. 7B, the remote computing device 622 may perform some or all of the functions described above with respect to the autonomous vehicle alone in FIG. 7A. In one embodiment, the location element 606 determines a location of the autonomous vehicle 602 and sends an indication of the location to the processing element 604. The processing element 604 causes the communication interface 610 to send the indication of the location across the network 620 to the remote computing device 622. The remote computing device 622 is configured to identify a proximity sensor height for the location of the autonomous vehicle 602 from memory located in and/or communicatively coupled to the remote computing device 622. After the remote computing device 622 identifies the proximity sensor height, it sends an indication of the proximity sensor height to the autonomous vehicle 602 via the network 620 and the communication interface 610. The communication interface 610 communicates the proximity sensor height to the processing element 604 and the processing element 604 controls the height of the proximity sensor 614 by instructing the movement mechanism 612 to change the height of the proximity sensor 614 based on the proximity sensor height. While this is one embodiment of how the remote computing device 622 may perform some or all of the functions described above with respect to the autonomous vehicle alone in FIG. 7A, there are many other ways in which the functions may be shared between the autonomous vehicle 602 and the remote computing device 622.

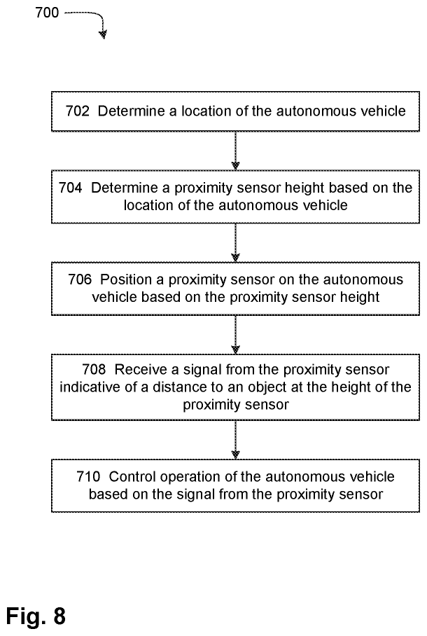

Depicted in FIG. 8 is an embodiment of a method 700 for using a variable-height proximity sensor on an autonomous vehicle. At block 702, a location of the autonomous vehicle is determined. In some embodiments, the location of the autonomous vehicle can be determined by the autonomous vehicle (e.g., a location element within the autonomous vehicle) or by a remote computing device. In some embodiments, the location element is a device configured to receive signals usable to determine the location of the autonomous vehicle, such as a GPS receiver configured to receive GPS signals, a wireless communication receiver configured to receive wireless signals from beacons (e.g., WiFi hotspots, Bluetooth location beacons, etc.), or any other wireless signals. In some embodiments, the location element includes computer-executable instructions that, upon execution by a processing element, cause the autonomous vehicle to determine its location based on a comparison of readings from on-board sensors to a map of the environment stored in the autonomous vehicle. In some embodiments, the location of the autonomous vehicle includes a position of the autonomous vehicle, an orientation of the autonomous vehicle, or a combination thereof. In some embodiments, the location of the autonomous vehicle is determined to be an unknown location or in an unmapped location, such as in the case where the location is determined based on on-board sensor readings and the autonomous vehicle is unable to determine a known location or a mapped location based on the on-board sensor readings.

At block 704, a proximity sensor height is determined based on the location of the autonomous vehicle. In some embodiments, the autonomous vehicle determines the proximity sensor height by identifying the proximity sensor height in a memory, such as a lookup table that includes various proximity sensor heights for different locations of the autonomous vehicle. In some embodiments, the autonomous vehicle determines the proximity sensor height based on sensor readings of the environment, such as determining a particular proximity sensor height based on a three-dimensional scan of the environment. In some embodiments, a remote computing device determines the proximity sensor height by identifying the proximity sensor height in a memory or by determining a particular proximity sensor height based on a three-dimensional map of the environment. In some embodiments, the autonomous vehicle is in a location that does not have a pre-associated proximity sensor height. In some examples, the autonomous vehicle determines the proximity sensor height using sensor readings from an on-board sensor, such as by moving the movable proximity sensor through a range of the possible heights of the movable proximity sensor and selecting one of the possible heights as the proximity sensor height based on the readings of the movable proximity sensor through the range of possible heights. In some examples, the location that does not have a pre-associated proximity sensor height may be an unknown location or an unmapped location.

At block 706, a proximity sensor on the autonomous vehicle is positioned on the autonomous vehicle based on the proximity sensor height. In one example, the autonomous vehicle includes a movement mechanism configured to move the proximity sensor on the autonomous vehicle. In some cases, the movement mechanism is instructed by a processing element on the autonomous vehicle or a remote computing device to move the proximity sensor based on the proximity sensor height. In some embodiments, the proximity sensor is configured to be placed at one of a number of distinct sensor heights. In other embodiments, the proximity sensor is configured to be placed at one of any number of heights within a range of heights.

At block 708, a signal is received from the proximity sensor indicative of a distance to an object at the proximity sensor height. In some embodiments, the proximity sensor emits a field, such as electromagnetic energy or sound waves, and detects reflection of that field to determine a distance to the object. In some embodiments, the signal indicative of the distance to the object is received by a component in the autonomous vehicle (e.g., a processing element) and/or a remote computing device. In some embodiments, the distance to the object is the distance to an expected portion of the object (e.g., a portion of the produce island 526 above the bumper 542, a portion of the kickplate 546 below the individual shelves 544, etc.). In some cases, the autonomous vehicle and/or the remote computing device that receives the signal indicative of the distance to the object is configured to estimate a location of a different portion of the object (e.g., the end of the bumper 542, the end of the individual shelves 544, etc.) based on the signal indicative of the distance to the object.

At block 710, one or more operations of the autonomous vehicle are controlled based on the signal from the proximity sensor indicative of the distance to the object. In some embodiments, the one or more operations of the autonomous vehicle include a position of the autonomous vehicle, an orientation of the autonomous vehicle, a speed of the autonomous vehicle, an acceleration of the autonomous vehicle, a type of floor cleaning performed by the autonomous vehicle, any other operation of the autonomous vehicle, or any combination thereof. In one embodiment, the signal from the proximity sensor is used for navigation guidance and the orientation and/or speed of the autonomous vehicle is controlled to maintain a particular route. In another embodiment, the signal from the proximity sensor is used for object avoidance and the orientation and/or speed of the autonomous vehicle is controlled to avoid an object in its path. In other embodiments any other operation of the autonomous vehicle is controlled based on the signal from the proximity sensor. In some embodiments, controlling the operation of the autonomous vehicle is performed by the autonomous vehicle and/or a remote computing device.

The embodiment of the method 700 is depicted as a series of steps performed in a particular order. It should be noted that, in other embodiments, some of the steps may be performed in a different order than the order presented in FIG. 8. In addition, in other embodiments, a method may be performed that does not include all of the steps shown in FIG. 8. For example, a method may be performed that includes the steps shown at blocks 702, 704, 706, and 708 without also performing the step shown at block 710. Other variations of the method 700 may be performed with one or more of the steps omitted.

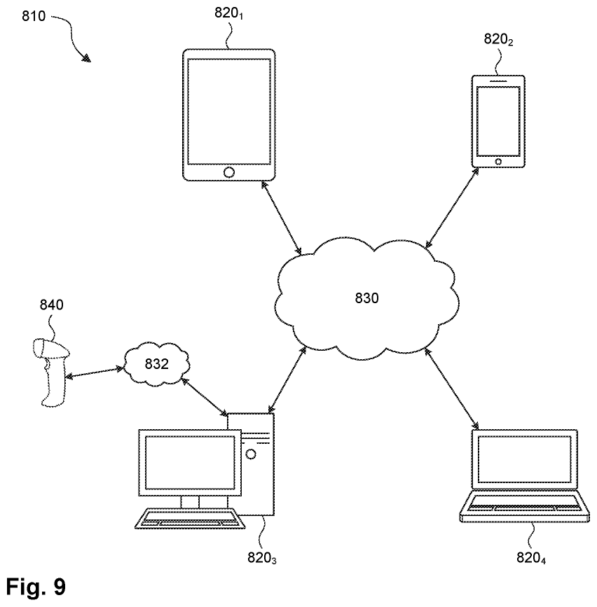

FIG. 9 depicts an example embodiment of a system 810 that may be used to implement some or all of the embodiments described herein. In the depicted embodiment, the system 810 includes computing devices 820₁, 820₂, 820₃, and 820₄ (collectively computing devices 820). In the depicted embodiment, the computing device 820₁ is a tablet, the computing device 820₂ is a mobile phone, the computing device 820₃ is a desktop computer, and the computing device 820₄ is a laptop computer. In other embodiments, the computing devices 820 include one or more of a desktop computer, a mobile phone, a tablet, a phablet, a notebook computer, a laptop computer, a distributed system, a gaming console (e.g., Xbox, Play Station, Wii), a watch, a pair of glasses, a key fob, a radio frequency identification (RFID) tag, an ear piece, a scanner, a television, a dongle, a camera, a wristband, a wearable item, a kiosk, an input terminal, a server, a server network, a blade, a gateway, a switch, a processing device, a processing entity, a set-top box, a relay, a router, a network access point, a base station, any other device configured to perform the functions, operations, and/or processes described herein, or any combination thereof.

The computing devices 820 are communicatively coupled to each other via one or more networks 830 and 832. Each of the networks 830 and 832 may include one or more wired or wireless networks (e.g., a 3G network, the Internet, an internal network, a proprietary network, a secured network). The computing devices 820 are capable of communicating with each other and/or any other computing devices via one or more wired or wireless networks. While the particular system 810 in FIG. 9 depicts that the computing devices 820 communicatively coupled via the network 830 include four computing devices, any number of computing devices may be communicatively coupled via the network 830.

In the depicted embodiment, the computing device 820₃ is communicatively coupled with a peripheral device 840 via the network 832. In the depicted embodiment, the peripheral device 840 is a scanner, such as a barcode scanner, an optical scanner, a computer vision device, and the like. In some embodiments, the network 832 is a wired network (e.g., a direct wired connection between the peripheral device 840 and the computing device 820₃), a wireless network (e.g., a Bluetooth connection or a WiFi connection), or a combination of wired and wireless networks (e.g., a Bluetooth connection between the peripheral device 840 and a cradle of the peripheral device 840 and a wired connection between the peripheral device 840 and the computing device 820₃). In some embodiments, the peripheral device 840 is itself a computing device (sometimes called a “smart” device). In other embodiments, the peripheral device 840 is not a computing device (sometimes called a “dumb” device).

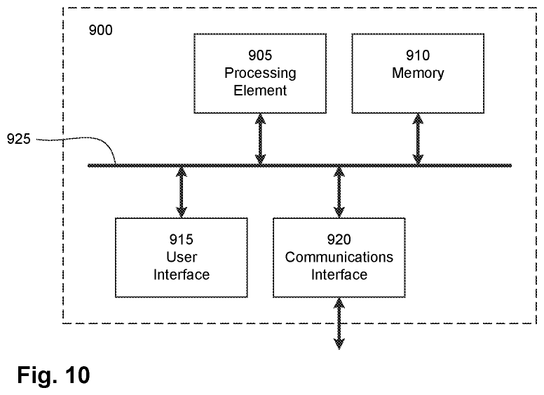

Depicted in FIG. 10 is a block diagram of an embodiment of a computing device 900. Any of the computing devices 820 and/or any other computing device described herein may include some or all of the components and features of the computing device 900. In some embodiments, the computing device 900 is one or more of a desktop computer, a mobile phone, a tablet, a phablet, a notebook computer, a laptop computer, a distributed system, a gaming console (e.g., an Xbox, a Play Station, a Wii), a watch, a pair of glasses, a key fob, a radio frequency identification (RFID) tag, an ear piece, a scanner, a television, a dongle, a camera, a wristband, a wearable item, a kiosk, an input terminal, a server, a server network, a blade, a gateway, a switch, a processing device, a processing entity, a set-top box, a relay, a router, a network access point, a base station, any other device configured to perform the functions, operations, and/or processes described herein, or any combination thereof. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein.

In the depicted embodiment, the computing device 900 includes a processing element 905, memory 910, a user interface 915, and a communications interface 920. The processing element 905, memory 910, a user interface 915, and a communications interface 920 are capable of communicating via a communication bus 925 by reading data from and/or writing data to the communication bus 925. The computing device 900 may include other components that are capable of communicating via the communication bus 925. In other embodiments, the computing device does not include the communication bus 925 and the components of the computing device 900 are capable of communicating with each other in some other way.

The processing element 905 (also referred to as one or more processors, processing circuitry, and/or similar terms used herein) is capable of performing operations on some external data source. For example, the processing element may perform operations on data in the memory 910, data receives via the user interface 915, and/or data received via the communications interface 920. As will be understood, the processing element 905 may be embodied in a number of different ways. In some embodiments, the processing element 905 includes one or more complex programmable logic devices (CPLDs), microprocessors, multi-core processors, co processing entities, application-specific instruction-set processors (ASIPs), microcontrollers, controllers, integrated circuits, application specific integrated circuits (ASICs), field programmable gate arrays (FPGAs), programmable logic arrays (PLAs), hardware accelerators, any other circuitry, or any combination thereof. The term circuitry may refer to an entirely hardware embodiment or a combination of hardware and computer program products. In some embodiments, the processing element 905 is configured for a particular use or configured to execute instructions stored in volatile or nonvolatile media or otherwise accessible to the processing element 905. As such, whether configured by hardware or computer program products, or by a combination thereof, the processing element 905 may be capable of performing steps or operations when configured accordingly.

The memory 910 in the computing device 900 is configured to store data, computer-executable instructions, and/or any other information. In some embodiments, the memory 910 includes volatile memory (also referred to as volatile storage, volatile media, volatile memory circuitry, and the like), non-volatile memory (also referred to as non-volatile storage, non-volatile media, non-volatile memory circuitry, and the like), or some combination thereof.

In some embodiments, volatile memory includes one or more of random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, any other memory that requires power to store information, or any combination thereof.

In some embodiments, non-volatile memory includes one or more of hard disks, floppy disks, flexible disks, solid-state storage (SSS) (e.g., a solid state drive (SSD)), solid state cards (SSC), solid state modules (SSM), enterprise flash drives, magnetic tapes, any other non-transitory magnetic media, compact disc read only memory (CD ROM), compact disc-rewritable (CD-RW), digital versatile disc (DVD), Blu-ray disc (BD), any other non-transitory optical media, read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, Memory Sticks, conductive-bridging random access memory (CBRAM), phase-change random access memory (PRAM), ferroelectric random-access memory (FeRAM), non-volatile random access memory (NVRAM), magneto-resistive random access memory (MRAM), resistive random-access memory (RRAM), Silicon Oxide-Nitride-Oxide-Silicon memory (SONOS), floating junction gate random access memory (FJG RAM), Millipede memory, racetrack memory, any other memory that does not require power to store information, or any combination thereof.

In some embodiments, memory 910 is capable of storing one or more of databases, database instances, database management systems, data, applications, programs, program modules, scripts, source code, object code, byte code, compiled code, interpreted code, machine code, executable instructions, or any other information. The term database, database instance, database management system, and/or similar terms used herein may refer to a collection of records or data that is stored in a computer-readable storage medium using one or more database models, such as a hierarchical database model, network model, relational model, entity relationship model, object model, document model, semantic model, graph model, or any other model.

The user interface 915 of the computing device 900 is in communication with one or more input or output devices that are capable of receiving inputs into and/or outputting any outputs from the computing device 900. Embodiments of input devices include a keyboard, a mouse, a touchscreen display, a touch sensitive pad, a motion input device, movement input device, an audio input, a pointing device input, a joystick input, a keypad input, peripheral device 840, foot switch, and the like. Embodiments of output devices include an audio output device, a video output, a display device, a motion output device, a movement output device, a printing device, and the like. In some embodiments, the user interface 915 includes hardware that is configured to communicate with one or more input devices and/or output devices via wired and/or wireless connections.

The communications interface 920 is capable of communicating with various computing devices and/or networks. In some embodiments, the communications interface 920 is capable of communicating data, content, and/or any other information, that can be transmitted, received, operated on, processed, displayed, stored, and the like. Communication via the communications interface 920 may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, communication via the communications interface 920 may be executed using a wireless data transmission protocol, such as general packet radio service (GPRS), Universal Mobile Telecommunications System (UMTS), Code Division Multiple Access 2000 (CDMA2000), CDMA2000 1x (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (WiFi), WiFi Direct, 802.16 (WiMAX), ultra wideband (UWB), infrared (IR) protocols, near field communication (NFC) protocols, Wibree, Bluetooth protocols, wireless universal serial bus (USB) protocols, or any other wireless protocol.

As will be appreciated by those skilled in the art, one or more components of the computing device 900 may be located remotely from other components of the computing device 900 components, such as in a distributed system. Furthermore, one or more of the components may be combined and additional components performing functions described herein may be included in the computing device 900. Thus, the computing device 900 can be adapted to accommodate a variety of needs and circumstances. The depicted and described architectures and descriptions are provided for exemplary purposes only and are not limiting to the various embodiments described herein.

Embodiments described herein may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

As should be appreciated, various embodiments of the embodiments described herein may also be implemented as methods, apparatus, systems, computing devices, and the like. As such, embodiments described herein may take the form of an apparatus, system, computing device, and the like executing instructions stored on a computer readable storage medium to perform certain steps or operations. Thus, embodiments described herein may be implemented entirely in hardware, entirely in a computer program product, or in an embodiment that comprises combination of computer program products and hardware performing certain steps or operations.

Embodiments described herein may be made with reference to block diagrams and flowchart illustrations. Thus, it should be understood that blocks of a block diagram and flowchart illustrations may be implemented in the form of a computer program product, in an entirely hardware embodiment, in a combination of hardware and computer program products, or in apparatus, systems, computing devices, and the like carrying out instructions, operations, or steps. Such instructions, operations, or steps may be stored on a computer readable storage medium for execution by a processing element in a computing device. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

What is claimed is:

1. A method of using an autonomous vehicle, wherein the autonomous vehicle is configured to move across a floor surface in an environment, wherein the autonomous vehicle includes a proximity sensor that is positionable at different heights on the autonomous vehicle, the method comprising:
determining a location of the autonomous vehicle within the environment;
determining a proximity sensor height based on the location of the autonomous vehicle within the environment;
positioning the proximity sensor at a height on the autonomous vehicle based on the proximity sensor height; and
receiving, from the proximity sensor, a signal indicative of a distance to an object within the environment at the height of the proximity sensor on the autonomous vehicle.

2. The method of claim 1, wherein determining the location, determining the proximity sensor height, positioning the proximity sensor, and receiving the signal are performed by the autonomous vehicle.

3. The method of claim 1, wherein determining the location, determining the proximity sensor height, positioning the proximity sensor, and receiving the signal are performed by at least one of the autonomous vehicle and a remote computing device.

4. The method of claim 3, wherein each of the autonomous vehicle and the remote computing device performs at least one of determining the location, determining the proximity sensor height, positioning the proximity sensor, and receiving the signal.

5. The method of claim 3, wherein the autonomous vehicle is communicatively coupled to the remote computing device via a network.

6. The method of claim 1, further comprising:
controlling an operation of the autonomous vehicle based on the signal indicative of the distance to the object.

7. The method of claim 6, wherein the operation of the autonomous vehicle includes at least one of a position of the autonomous vehicle, an orientation of the autonomous vehicle, a speed of the autonomous vehicle, or an acceleration of the autonomous vehicle.

8. The method of claim 6, wherein the operation of the autonomous vehicle includes one or more of navigation relative to the object in the environment or object avoidance of the object in the environment.

9. The method of claim 1, wherein the proximity sensor is positionable at a distinct number of different heights on the autonomous vehicle.

10. The method of claim 1, wherein the proximity sensor is positionable at any height within a range of heights on the autonomous vehicle.

11. The method of claim 1, wherein positioning the proximity sensor is performed while the autonomous vehicle is moving across the floor surface in the environment.

12. The method of claim 1, wherein determining the proximity sensor height based on the location of the autonomous vehicle within the environment comprises:
determining that the location of the autonomous vehicle does not have a pre-associated proximity sensor height; and
determining the proximity sensor height using sensor readings from an on-board sensor.

13. The method of claim 12, wherein the proximity sensor is the on-board sensor, and wherein determining the proximity sensor height comprises:
moving the proximity sensor to a number of the different heights; and
selecting one of the number of the different heights as the proximity sensor height based on readings of the proximity sensor at the number of the different heights.

14. The method of claim 12, wherein the location of the autonomous vehicle that does not have a pre-associated proximity sensor height is an unknown location or an unmapped location.

15. A system comprising:
an autonomous vehicle configured to move across a floor surface of an environment;
a location element configured to determine a location of the autonomous vehicle within the environment;
a proximity sensor coupled to the autonomous vehicle; and
a movement mechanism configured to position the proximity sensor at different heights on the autonomous vehicle;
wherein the movement mechanism is configured to position the proximity sensor in response to receiving instructions based on a proximity sensor height, and wherein the proximity sensor height is determined based on the location of the autonomous vehicle determined by the location element; and
wherein the proximity sensor is configured to generate a signal indicative of a distance to an object within the environment at the height of the proximity sensor on the autonomous vehicle.

16. The system of claim 15, wherein the autonomous vehicle further comprises at least one processing element and at least one memory having instructions stored therein, wherein the instructions, in response to execution by the at least one processing element, cause the autonomous vehicle to:
determine the proximity sensor height based on the location of the autonomous vehicle determined by the location element; and
instruct the movement mechanism to position the proximity sensor based on the proximity sensor height.

17. The system of claim 16, wherein the instructions, in response to execution by the at least one processing element, further cause the autonomous vehicle to:
control an operation of the autonomous vehicle based on the signal indicative of the distance to the object.

18. The system of claim 17, wherein the operation of the autonomous vehicle includes at least one of a position of the autonomous vehicle, an orientation of the autonomous vehicle a speed of the autonomous vehicle, or an acceleration of the autonomous vehicle.

19. The system of claim 17, wherein the operation of the autonomous vehicle includes one or more of navigation relative to the object in the environment or object avoidance of the object in the environment.

20. The system of claim 15, further comprising:
a housing having at least one aperture, wherein the proximity sensor is configured to direct a field through the at least one aperture toward the object in the environment.

21. The system of claim 20, wherein the at least one aperture includes a plurality of apertures, and wherein the movement mechanism is configured to selectively position the proximity sensor at one of the plurality of apertures.

22. The system of claim 20, wherein the at least one aperture includes an elongated aperture, and wherein the movement mechanism is configured to selectively position the proximity sensor at any height between a lower end of the elongated aperture and an upper end of the elongated aperture.

23. The system of claim 15, further comprising:
a remote computing device communicatively coupled to the autonomous vehicle via a network;
wherein the remote computing device is configured to perform at least one of determining the location of the autonomous vehicle, determining the proximity sensor height based on the location of the autonomous vehicle, or instructing the movement mechanism to position the proximity sensor based on the proximity sensor height.

24. A non-transitory computer-readable medium having instructions embodied thereon for using an autonomous vehicle, wherein the autonomous vehicle is configured to move across a floor surface in an environment, wherein the autonomous vehicle includes a proximity sensor that is positionable at different heights on the autonomous vehicle, and wherein the instructions, in response to execution by a processing element in the autonomous vehicle, cause the autonomous vehicle to:
determine a location of the autonomous vehicle within the environment;
determine a proximity sensor height based on the location of the autonomous vehicle within the environment;
position the proximity sensor at a height on the autonomous vehicle based on the proximity sensor height; and
receive, from the proximity sensor, a signal indicative of a distance to an object within the environment at the height of the proximity sensor on the autonomous vehicle.

25. The non-transitory computer-readable medium of claim 24, wherein the instructions, in response to execution by the processing element in the autonomous vehicle, further cause the autonomous vehicle to:
control an operation of the autonomous vehicle based on the signal indicative of the distance to the object.

26. The non-transitory computer-readable medium of claim 25, wherein the operation of the autonomous vehicle includes at least one of a position of the autonomous vehicle, an orientation of the autonomous vehicle, a speed of the autonomous vehicle, or an acceleration of the autonomous vehicle.

27. The non-transitory computer-readable medium of claim 25, wherein the operation of the autonomous vehicle includes one or more of navigation relative to the object in the environment or object avoidance of the object in the environment.

28. The non-transitory computer-readable medium of claim 24, wherein the proximity sensor is positionable at a distinct number of different heights on the autonomous vehicle.

29. The non-transitory computer-readable medium of claim 24, wherein the proximity sensor is positionable at any height within a range of heights on the autonomous vehicle.

30. The non-transitory computer-readable medium of claim 24, wherein the instructions to position the proximity sensor cause the proximity sensor to be positioned while the autonomous vehicle is moving across the floor surface in the environment.
